(19) United States
(12) Patent Application Publication
(10) Pub. No.: US 2009/0289879 A1
(43) Pub. Date: Nov. 26, 2009

(54) IMAGE DISPLAY DEVICE AND IMAGE DISPLAY METHOD

(75) Inventors: Ken Ito, Kanagawa (JP); Masaki Tsuchida, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/348,793

(22) Filed: Jan. 5, 2009

(30) Foreign Application Priority Data
May 26, 2008 (JP) 2008-137020

(51) Int. Cl. G09G 3/36; G06K 9/40

(52) U.S. Cl. 345/87; 382/260

(57) ABSTRACT

According to one embodiment, an image display device includes an image-signal input module, an image-quality corrector, a light emitter, and a liquid-crystal display module. The image-signal input module receives an image signal. The image-quality corrector performs, based on an image-quality correction amount, an image-quality correction process on the image signal. The light emitter includes a plurality of light sources for emitting light. The liquid-crystal display module modulates, among light emitted from the light sources, light transmitted through the liquid crystal to display an image according to the image signal subjected to the image-quality correction process. The light emitter emits the light according to the image signal with less image-quality correction amount than that of the image signal subjected to the image-quality correction process.

### CROSS-REFERENCE TO RELATED APPLICATIONS

This application is based upon and claims the benefit of priority from Japanese Patent Application No. 2008-137020, filed May 26, 2008, the entire contents of which are incorporated herein by reference.

### BACKGROUND

1. Field

One embodiment of the invention relates to an image display device and an image display method, and, more particularly, relates to an image display device and an image display method for displaying an image by using a plurality of light sources after correction of image quality.

2. Description of the Related Art

There have been proposed liquid-crystal displays that correct image quality based on a set image-quality correction amount. For example, Japanese Patent Application Publication (KOKAI) No. 2007-143122 discloses a conventional liquid-crystal display device that sets, to control backlight luminance according to an average picture level (APL) of image signals measured by an APL measuring unit, follow-up of change in the backlight luminance with respect to change in a feature amount of the image signals according to a genre such that a displayed image can be viewed comfortably. In the conventional liquid-crystal display device, the APL of the image signals measured by the APL measuring unit is input to a filter, and by controlling a weighted mean of APL changes on the time axis, the follow-up of backlight luminance control is controlled. The conventional liquid-crystal display device determines the genre of an image to be displayed, and changes a constant used for the weighted mean of the filter based on the genre, thereby optimizing display quality for each genre.

In an image display device with a backlight that includes a plurality of light sources arranged for one of a plurality of areas and that can control illumination of the light sources for each of the areas, when image quality is corrected by horizontal and vertical edge enhancement or overdrive measures, luminance of the area subjected to the edge enhancement is higher than that of the area not subjected to the edge enhancement. Thus, the light or illumination value of the backlight varies in each area. Due to this, luminance unevenness occurs over screen display and flickering may occur on the screen at the time of displaying a moving image.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an image display device according to a first embodiment of the invention;

FIG. 2 is an exemplary schematic diagram of a basic waveform at a level of image-quality enhancement with respect to a horizontal position in the embodiment;

FIG. 3 is an exemplary schematic diagram of a waveform with edges enhanced at a level of image-quality enhancement with respect to the horizontal position in the embodiment;

FIG. 4 is an exemplary schematic diagram of a waveform with edges distorted at a level of image-quality enhancement with respect to the horizontal position in the embodiment;

FIG. 5 is an exemplary schematic diagram of the maximum value of each area as a feature value of the basic waveform at a level of image-quality enhancement with respect to the horizontal position in the embodiment;

FIG. 6 is an exemplary schematic diagram of the maximum value of each area as a feature value of the waveform with edges enhanced at a level of image-quality enhancement with respect to the horizontal position in the embodiment;

FIG. 7 is an exemplary schematic diagram of the maximum value of each area as a feature value of the waveform with edges distorted at a level of image-quality enhancement with respect to the horizontal position in the embodiment;

FIG. 8 is an exemplary schematic diagram for explaining variation in light value depending on sampling position in the embodiment;

FIG. 9 is an exemplary graph of gain with respect to the frequency of a filter processor in the embodiment; and

FIG. 10 is an exemplary block diagram of an image display device according to a second embodiment of the invention.

### DETAILED DESCRIPTION

Various embodiments according to the invention will be described hereinafter with reference to the accompanying drawings. In general, according to one embodiment of the invention, an image display device includes: an image-signal input module configured to receive an image signal; an image-quality corrector configured to perform, based on an image-quality correction amount, an image-quality correction process for correcting image quality on the image signal received through the image-signal input module; a light emitter that includes a plurality of light sources each arranged in one of a plurality of areas, the light emitter being configured to emit light from each of the light sources; and a liquid-crystal display module configured to modulate, among light emitted from the light sources, light transmitted through a liquid crystal to display an image according to the image signal subjected to the image-quality correction process performed by the image-quality corrector based on the image-quality correction amount. The light emitter emits the light from each of the light sources according to the image signal with less image-quality correction amount than the image-quality correction amount of the image signal subjected to the image-quality correction process.

According to another embodiment of the invention, an image display method includes: receiving an image signal; performing, based on an image-quality correction amount, an image-quality correction process for correcting image quality on the image signal received at the receiving; emitting light from each of a plurality of light sources each arranged in one of a plurality of areas; and modulating, among light emitted from the light sources, light transmitted through a liquid crystal to display an image according to the image signal subjected to the image-quality correction process performed based on the image-quality correction amount. The light is emitted from each of the light sources according to the image signal with less image-quality correction amount than the image-quality correction amount of the image signal subjected to the image-quality correction process.

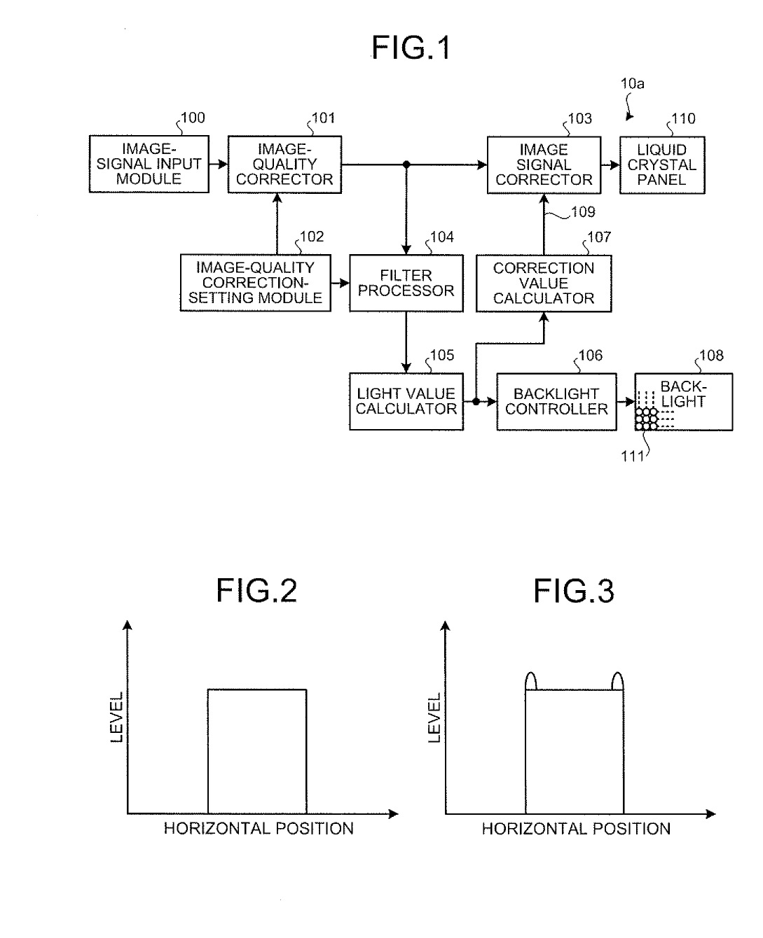

FIG. 1 is a block diagram of an image display device according to a first embodiment of the invention. As illustrated in FIG. 1, an image display device 10a of the first embodiment includes an image-signal input module 100, an image-quality corrector 101, an image-quality correction-setting module 102, an image signal corrector 103, a filter processor 104, a light value calculator 105, a backlight controller 106, a correction value calculator 107, a backlight 108, and a liquid crystal panel 110.

The image-signal input module 100 inputs, to a subsequent block, video contents received from a television (TV) tuner and a network line or image signals related to video contents stored in a storage medium such as a hard disk drive (HDD) and a digital versatile disk (DVD). Image signals received by the image-signal input module 100 are input to the image-quality corrector 101.

Based on characteristic data set by the image-quality correction-setting module 102, the image-quality corrector 101 performs the image-quality correction process for the image signals from the image-signal input module 100. Examples of the image-quality correction process that can be set by the image-quality correction-setting module 102 include edge enhancement for enhancing edges of an image to be displayed in the horizontal direction and the vertical direction and overdrive for enhancing a changed portion of an image to improve the response of the liquid crystal panel 110. The image signals subjected to the image-quality correction process by the image-quality corrector 101 are input to the image signal corrector 103 and the filter processor 104.

The filter processor 104 receives the characteristic data set by the image-quality correction-setting module 102 for the image-quality corrector 101. Based on the characteristic data, the filter processor 104 changes filter characteristics for the image signals subjected to the image-quality correction process received from the image-quality corrector 101. The image signals subjected to filtering by the filter processor 104 are input to the light value calculator 105.

The light value calculator 105 detects a feature value for calculating the light value of a light source 111 of each area in the backlight 108 from the filtered image signals received from the filter processor 104. Based on the feature value, the light value calculator 105 calculates the light value of the light source 111 of each area. The light value calculated by the light value calculator 105 is input to the backlight controller 106 and the correction value calculator 107.

Based on the light value received from the light value calculator 105, the backlight controller 106 controls illumination of the light source 111 of each area in the backlight 108 connected thereto. The backlight 108 includes a plurality of areas each having the light source 111. According to a control signal from the backlight controller 106, the light source 111 of each area emits light of the light value calculated by the light value calculator 105.

Based on the light value received from the light value calculator 105, the correction value calculator 107 calculates change in luminance of the light source 111 of each area in the backlight 108, and then calculates a correction value for the image signals of the image to be displayed on the liquid crystal panel 110. A correction value 109 calculated by the correction value calculator 107 is input to the image signal corrector 103.

The image signal corrector 103 corrects the image signals from the image-quality corrector 101 with respect to change in illumination state of the backlight 108 due to filtering of the filter processor 104 based on the correction value 109 calculated by the correction value calculator 107. The image signals corrected by the image signal corrector 103 are input to the liquid crystal panel 110. From the light emitted by the respective ON light sources 111 in the backlight 108, the liquid crystal panel 110 modulates light transmitted through the liquid crystal to display the image.

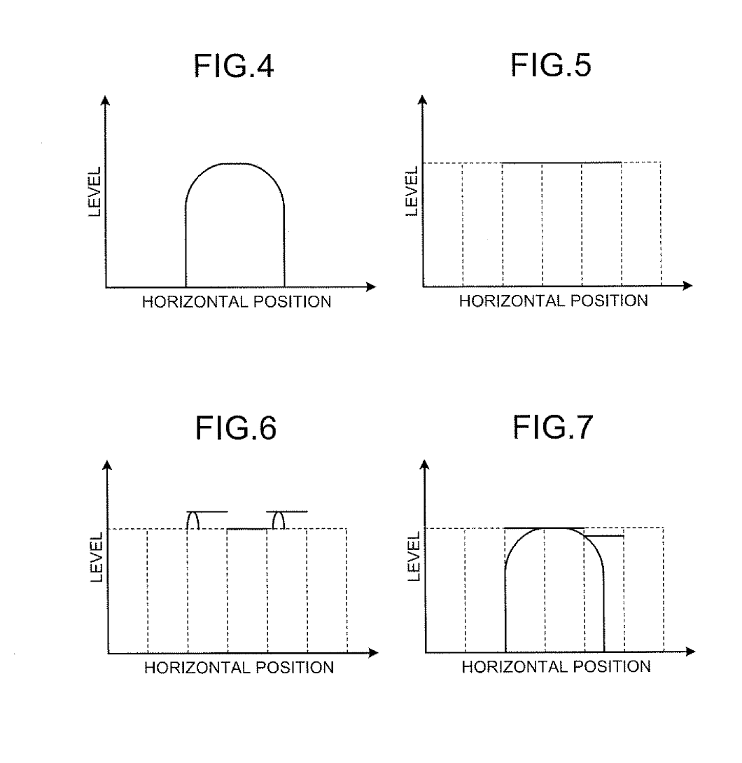

Described below is the operation of the image display device 10a of the first embodiment. FIGS. 2 to 4 illustrate the image signal level with respect to a horizontal position for explaining image-quality correction. A waveform illustrated in FIG. 2 is assumed herein as a basic waveform. By image-quality correction for enhancing an edge of an image to be displayed, as illustrated in FIG. 3, the edge of the waveform is sharpened as compared to the flat portion. On the other hand, by image-quality correction for making the edge blunt, a smooth waveform as illustrated in FIG. 4 is formed. For such a smooth waveform, for example, the maximum value of the image signal level of each area is calculated as a feature value for calculating the light value of each of the light sources 111 in the backlight 108.

In FIGS. 5 to 7, a dashed line portion indicates a range of an area and a bold line portion indicates the maximum value of the image signal level of the area, As illustrated in FIG. 5, in the basic waveform illustrated in FIG. 2, the maximum value is uniform in each area. On the other hand, as illustrated in FIGS. 3 and 4, in the waveform subjected to image-quality correction, the maximum value varies for each area.

If the light value of the backlight 108 is calculated by using as the feature value the maximum value of the image signal level of each area, which has changed due to image-quality correction, the correction value calculator 107 is required to precisely correct image signals of an image displayed on the liquid crystal panel 110 such that the brightness is the same in respective areas that are illuminated by different light values although the image signals are of the same value as input signals. In some cases, unevenness is perceptible in luminance. If an average value of the image signal level is used as the feature value, although less compared to the case of using the maximum value of the image signal level as the feature value, the average value changes in a similar manner in each area.

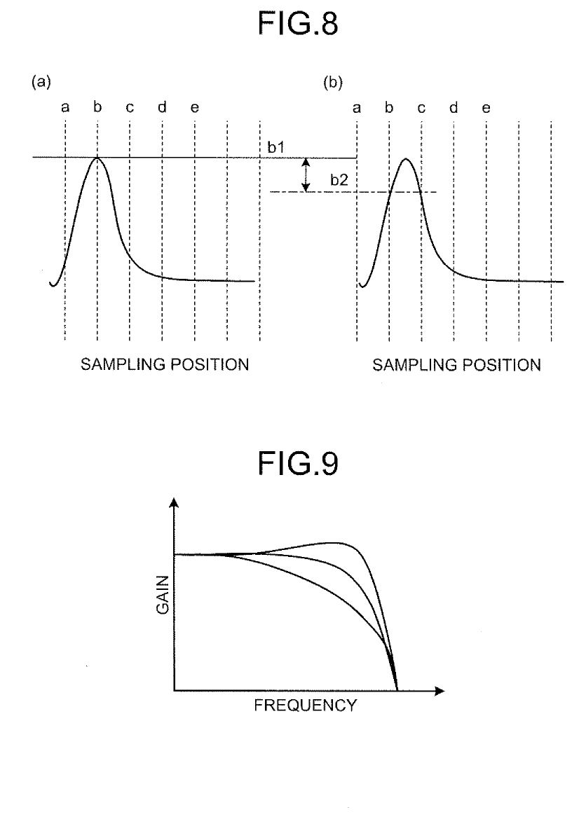

In FIG. 8 illustrates effects of the feature value with respect to a sampling position for sampling the image signal level. As indicated by (a) and (b) of FIG. 8, assuming that an object having enhanced edges moves on the screen, the image signal level varies according to the sampling position. Thus, as the object moves on the screen, the feature value changes and the calculated light value changes from b1 to b2. Although this characteristic is suitable from the image-quality point of view, such a process is not required to obtain the feature value for calculating the light value of the backlight 108 and causes changes in the light value of the backlight 108. Thus, when the light value of the backlight 108 changes significantly, flickering is likely to occur on the screen.

According to the first embodiment, The filter processor 104 can obtain the characteristic data from the image-quality correction-setting module 102 that sets the characteristics of the image-quality correction process performed by the image-quality corrector 101 for image signals. Thus, with respect to the image signals subjected to the image-quality correction process, the filter processor 104 performs filtering with filter characteristics suppressing correction effects according to the image-quality correction amount. Example of image-quality adjustment include sharpening for raising high-frequency components. FIG. 9 illustrates filter characteristics reducing the image-quality correction amount by causing variations in the gain of high-frequency components. The image-quality correction amount in the image-quality correction process is variable depending on user settings and display mode. By the application of filtering with simply fixed characteristics, reduction of the image-quality correction amount may be not sufficient, or in excess to such an extent that signal components of original image signals are lost. However, according to the first embodiment, filtering is performed based on the image-quality correction amount from the image-quality correction-setting module 102 that sets the characteristics of the image-quality correction process. Therefore, the feature value based on an original image can be appropriately detected and the light value of the backlight 108 can be appropriately calculated.

For improving the response of the liquid crystal panel 110, overdrive is performed to enhance the changed portion of the image. If image signals with the enhanced changed portion of the image is used for calculating the light value, the light value has large changed components. However, according to the first embodiment, the filter characteristics can be set such that overdrive is suppressed. Thus, the light value of the backlight 108 does not change significantly and the backlight 108 can be controlled to be in the stable illumination state without flickering in a moving image display.

As described above, according to the first embodiment, even if an image signal is enhanced by the image-quality correction process, the light value of the backlight 108 can be calculated with the reduced effect of the enhancement. Thus, occurrence of uneven luminance on the flat portion or occurrence of flickering upon displaying the moving image can be reduced and the stable illumination state of the backlight 108 can be achieved.

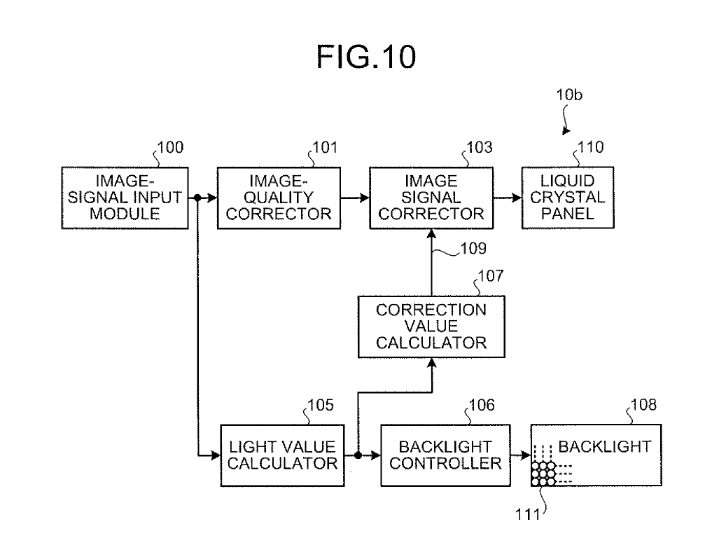

A second embodiment of the invention is explained below. FIG. 10 is a block diagram of an image display device 10b according to the second embodiment. As illustrated in FIG. 10, an image signal from the image-signal input module 100 is directly input to the light value calculator 105 without through the image-quality corrector 101. In other words, an image signal not subjected to the image-quality correction process by the image-quality corrector 101 is input to the light value calculator 105, and, based on the image signal before the image-quality correction process, the light value of the backlight 108 is calculated. Thus, the light value of the backlight 108 does not change significantly, and the backlight 108 can be controlled to be in the stable illumination state without flickering in moving image display. Furthermore, according to the second embodiment, a filter processor is not required differently from the first embodiment using the filter processor 104. Due to this, the structure of the image display device is simplified.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image display device comprising:
an image-signal input module configured to receive an image signal;
an image-quality corrector configured to perform, based on an image-quality correction amount, an image-quality correction process for correcting image quality on the image signal received through the image-signal input module;
a light emitter that includes a plurality of light sources each arranged in one of a plurality of areas, the light emitter being configured to emit light from each of the light sources; and
a liquid-crystal display module configured to modulate, among light emitted from the light sources, light transmitted through a liquid crystal to display an image according to the image signal subjected to the image-quality correction process performed by the image-quality corrector based on the image-quality correction amount, wherein
the light emitter emits the light from each of the light sources according to the image signal with less image-quality correction amount than the image-quality correction amount of the image signal subjected to the image-quality correction process.

2. The image display device according to claim 1, further comprising a filter processor that performs, for the image signal subjected to the image-quality correction process, filtering for reducing the image-quality correction amount of the image signal according to the image-quality correction amount, wherein
the light emitter emits the light from each of the light sources according to the image signal with an image-quality correction amount obtained by the filter processor by reducing the image-quality correction amount.

3. The image display device according to claim 1, wherein the light emitter emits the light from each of the light sources according to the image signal directly received from the image-signal input module.

4. The image display device according to claim 1, wherein the light emitter emits the light from each of the light sources according to a maximum value of the image signal for each of the areas in which each of the light sources is arranged.

5. The image display device according to claim 1, wherein the light emitter emits the light from each of the light sources according to an average value of the image signal for each of the areas in which each of the light sources is arranged.

6. The image display device according to claim 1, further comprising a correction value calculator that calculates a correction value according to the light emitted from each of the light sources of the light emitter, wherein
the liquid-crystal display device modulates the light transmitted through the liquid crystal according to the image signal subjected to the image-quality correction process and the correction value calculated by the correction value calculator.

7. An image display method comprising:
receiving an image signal;
performing, based on an image-quality correction amount, an image-quality correction process for correcting image quality on the image signal received at the receiving;
emitting light from each of a plurality of light sources each arranged in one of a plurality of areas; and
modulating, among light emitted from the light sources, light transmitted through a liquid crystal to display an image according to the image signal subjected to the image-quality correction process performed based on the image-quality correction amount, wherein
the light is emitted from each of the light sources according to the image signal with less image-quality correction amount than the image-quality correction amount of the image signal subjected to the image-quality correction process.

8. The image display method according to claim 7, further comprising filtering the image signal subjected to the image-quality correction process to reduce the image-quality correction amount of the image signal according to the image-quality correction amount, wherein
the light is emitted from each of the light sources according to the image signal with an image-quality correction amount obtained by reducing the image-quality correction amount at the filtering.

9. The image display method according to claim 7, wherein the light is emitted from each of the light sources according to the image signal without subjected to any process after the receiving.
